(19) United States
(12) Patent Application Publication
(10) Pub. No.: US 2025/0155773 A1
(43) Pub. Date: May 15, 2025

(54) REAL-TIME COMPUTER GENERATED HOLOGRAM (CGH) GENERATION BY COMPUTE UNIFIED DEVICE ARCHITECTURE (CUDA)-OPEN-GL FOR ADAPTIVE BEAM STEERING

(71) Applicant: ARIZONA BOARD OF REGENTS ON BEHALF OF THE UNIVERSITY OF ARIZONA, Tucson, AZ (US)

(72) Inventors: Yuzuru TAKASHIMA, Tucson, AZ (US); Chin-i TANG, Tucson, AZ (US); Xianyue DENG, Tucson, AZ (US)

(21) Appl. No.: 18/832,165

(22) PCT Filed: Jan. 24, 2023
(86) PCT No.: PCT/US2023/011396

§ 371 Date: Jul. 23, 2024

Related U.S. Application Data
(60) Provisional application No. 63/302,190, filed on Jan. 24, 2022.

(51) Int. Cl. G02F 1/29; G02B 26/08

(52) U.S. Cl. CPC G02F 1/292; G02B 26/0833; G02F 2203/12; G02F 2203/24

(57) ABSTRACT

A system and method for real-time, simultaneous, and adaptive beam steering into multiple regions of interest replaces conventional raster scanning, where only regions of interest are scanned by a laser or other optical beam. CUDA-OpenGL interoperability with a computationally time-efficient computer-generated hologram (CGH) calculation algorithm enables such beam steering by employing a phase-spatial light modulator (SLM). The real-time CGH generation and display algorithm is incorporated into the beam steering system with variable power and scan resolution, which are adaptively controlled by camera-based object recognition.

### CROSS REFERENCE TO RELATED APPLICATION

This application claims the benefit of U.S. Provisional Application No. 63/302,190, filed Jan. 24, 2022, the contents of which are incorporated herein with by reference.

### BACKGROUND

Laser beam steering (LBS) by using spatial light modulators (SLMs) has been adopted for a variety of scientific and industrial optical instruments and applications such as optical tweezers, optical switches, optical communication systems, and lidar. In LBS applications, computer-generated holograms (CGHs) displayed on a spatial light modulator (SLM) alter the phase and amplitude of illumination and, consequently, a diffraction pattern is manipulated. With a phase light modulator (PLM), the diffraction efficiency of a CGH for beam steering outperforms that of an amplitude-based CGH. In this regard, a phase CGH is suitable for applications with high optical throughput such as beam steering for lidar. Phase-based light modulation is commonly employed by SLMs such as a Liquid Crystal on Silicon (LCoS) SLM. In particular for lidar applications, the device area (A) is a critical aspect since the maximum detectable range scales with VA. Despite the large device area of LC-based devices, the slow response time of liquid crystal polymers limits the speed of beam scanning (frame rate) to up to hundreds of Hz. Moreover, linear polarization is required for a LCOS SLM. Due to the scattering of object surface, returning light from objects is not completely linear even when linearly polarized illumination is employed for a lidar transmitter. The polarization requirement reduces the photon throughput at least by half. The limited frame rate and polarization prohibit LC-based SLM devices from high-speed and high-efficiency beam steering applications.

A reflective and Micro Electro-Mechanical System (MEMS) SLM and PLM has recently become available. MEMS-SLMs are uniquely positioned in terms of device area, operation speed, and diversity in polarization for a lidar transmitter and receiver. Commercially available MEMS-SLMs, such as a Digital Micromirror Device (DMD) accommodates an array area of over 140 mm², operating at a tens of kHz frame rate. The MEMS-PLM modulates phase by piston motion of micromirror array; therefore, no polarization specific illumination is required. Beam steering by SLMs, however, including the MEMS-PLM, suffers from a relatively narrow scanning angle, on the order of λ/d, where λ and d are the wavelength and the pixel period, respectively. Recently, over 48 degrees of angular throw by diffractive beam steering is demonstrated by employing unpolarized short-pulse illumination in a synchronous manner to the movement of the MEMS mirror array of the DMD. The combination of two scanning modalities with pulsed illumination increases the number of scanning points while not sacrificing the fast refresh rate of MEMS-SLMs. As these developments indicate, with the large Etendue (product of area and angular throw) of arrayed MEMS-SLMs, laser beam steering is feasible with a high frame rate, a wide field of view, a large device area (consequently increased range for object detection), and a lower laser power density satisfying eye safety regulation.

In addition to MEMS-SLMs' high speed, large beam area, and large angle scanning operation, random access steering makes MEMS-PLMs even more attractive. Instead of scanning the entire field of view (FOV) in a sequential manner, the beam is steered into and scans the vicinity of the object. Such random-access scanning increases the scanning rate and the number of beams/s. Another interesting use case is camera-assisted and foveated lidar. For example, positions and relative distances among multiple objects are first estimated by using a camera. Based on the estimation, the MEMS-PLM steers beams into multiple objects to measure precise distance information. The camera-lidar hybrid object detection, or Foveation, makes the lidar system more adaptive; consequently, it solves challenges in lidars such as a strong reflection signal from retro-reflective objects, i.e., traffic signs. Additionally, the dynamic range of a lidar detector can be effectively increased by pre-adjusting the beam intensity to objects, based on the initial estimation of the relative distance of objects by camera. In this way, the signal levels returning from the multiple objects are equalized.

Foveated camera-lidar interoperability solves major challenges for lidar; however, it requires a fast and real-time calculation and display of a CGH without resorting to the iterative CGH calculation algorithm, along with interfacing the algorithm to the camera-based object detection. Such fast and non-iterative calculation of CGHs displaying simple objects such as line is reported by using a look-up table, and deep learning. For a more complex image, a single FFT-based CGH calculation is shown in Nishitsuji, T., Shimobara, T., Kakue, T., Ito, T. Fast calculation of computer-generated hologram of line-drawn objects without FFT. Opt. Express 2020, 28, 15907-15924; Horisaki, R., Takagi, R., Tanida, J. Deep-learning-generated holography. Appl. Opt. 2018, 57, 3859-3863; and Meng, D., Ulusoy, E., Urey, H. Non-iterative phase hologram computation for low speckle holographic image projection. Opt. Express 2016, 24, 4462-4476. A real-time CGH generated for displaying a relatively complex structure is also shown in Kakue, T., Wagatsuma, Y., Yamada, S., Nishitsuji, T., Endo, Y., Nagahama, Y., Hirayama, R.; Shimobaba, T., Ito, T. Review of real-time reconstruction techniques for aerial-projection holographic displays. Opt. Eng. 2018, 57, 061621-1-061621-11.

### SUMMARY

In accordance with one aspect of the systems and methods described herein, a real-time computer generated hologram (CGH) generation process for diffractive beam steering is presented. The process is able to generate a simpler pattern and scan multiple beams over a region of interest (ROI) while varying the beam intensity of those beams based on an input from camera. The whole process is able to satisfy the frame rate requirement of a modern lidar system.

In accordance with another aspect of the systems and methods described herein, a method is provided for performing adaptive beam steering to one or more objects of interest. The method includes: detecting an object of interest in an image of a scene; defining a region of interest (ROI) in the image to be scanned by an optical beam, wherein the ROI includes the object of interest; and determining a computer generated hologram (CGH) phase pattern to be applied to an optical beam by a phase Spatial Light Modulator (phase-SLM) to scan the optical beam over the ROI by diffractive beam steering. The determining is performed by a CGH calculation algorithm that is executed in parallel for each of the pixels, wherein the determining includes determining the CGH phase pattern on a pixel-by-pixel-basis by assigning a phase value to each pixel in the phase-SLM based on the equation: ϕ(x, y, a, b)=mod {[2π(xa+yb)], 2π}, where ϕ is the phase value, (x,y) represents a position of the pixel, and (a, b) represents a diffraction angle measured from a 0^{th} order diffraction from the phase-SLM and mod (2π(xa+yb), 2π) represents a modulo 2π operation on a value 2π(xa+yb). The method also includes displaying the CGH phase pattern on the phase-SLM using a graphic memory that is also used to determine the CGH phase pattern; and directing the optical beam onto the phase-SLM while the CGH phase pattern is being displayed to thereby steer the optical beam to the ROI.

In one embodiment, the method further includes simultaneously performing the various steps for a plurality of objects defined in a plurality of ROIs in the image by simultaneously steering a plurality of optical beams. In this embodiment the determining includes determining the CGH phase pattern so that the CGH pattern diffracts a single incoming illumination beam into multiple optical beams in such a way that each of the optical beams are directed towards different ROIs based on summing multiple diffracted electric fields, each of the diffracted electric fields diffracting light toward one of the ROIs followed by determining the CGH phase pattern as being represented as argument values of the summed multiple diffracted electric fields.

In another embodiment, determining the CGH phase pattern determines the CGH so that an energy distribution in the multiple optical beams is adjusted to equalize a strength of returning signals assuming that a ratio of an apparent extent of the objects in the plurality of objects depends on distance to the objects.

In another embodiment, the method further includes scanning the optical beam over the ROI.

In another embodiment, the method further includes performing foveated lidar using the scanned optical beam.

In another embodiment, determining the CGH phase pattern is performed using a graphical processing unit (GPU).

In another embodiment, the determining and displaying are performed using an interoperable compute unified device architecture (CUDA) and OpenGL platform.

In another embodiment, the phase-SLM is a phase light modulator (PLM).

In another embodiment, the phase-SLM is a Micro Electro-Mechanical System (MEMS)-PLM.

In another embodiment, the phase-SLM is a Liquid Crystal on Silicon (LCoS) SLM.

In another aspect of the subject matter described herein, an adaptive beam steering system is provided. The system includes a camera arrangement, an optical source, a phase spatial light modulator (phase-SLM) and a graphical processing unit (GPU). The camera arrangement is configured to detect at least one object of interest in a region of interest (ROI) located in an image of a scene. The optical source is configured to generate an optical beam and the (phase-SLM is arranged to receive the optical beam. The GPU is configured to determine a computer generated hologram (CGH) phase pattern to be applied to an optical beam by the phase-SLM to scan the optical beam over the ROI by diffractive beam steering. The GPU is further configured to determine the CGH phase pattern using a CGH calculation algorithm that is executed in parallel for each of the pixels, wherein the determining includes determining the CGH phase pattern on a pixel-by-pixel-basis by assigning a phase value to each pixel in the phase-SLM based on the equation: π(x, y, a, b)=mod {[2π(xa+yb)], 2π}, where ϕ is the phase value, (x,y) represents a position of the pixel, and (a, b) represents a diffraction angle measured from a 0^{th} order diffraction from the phase-SLM and mod (2π(xa+yb), 2π) represents a modulo 2π operation on a value 2π(xa+yb). The GPU is further configured to cause the CGH phase pattern to be displayed on the phase-SLM while the optical beam is being directed onto the phase-SLM to thereby steer the optical beam to the ROI.

In another embodiment, the camera arrangement is configured to detect a plurality of objects defined in a plurality of ROIs in the image. The GPU is further configured to cause simultaneous steering of a plurality of optical beams. The GPU is further configured to determine the CGH phase pattern so that the CGH pattern diffracts the optical beam into multiple optical beams in such a way that each of the multiple optical beams are directed towards different ROIs based on summing multiple diffracted electric fields. Each of the diffracted electric fields diffract light toward one of the ROIs followed by determining the CGH phase pattern as being represented as argument values of the summed multiple diffracted electric fields.

In another embodiment, the CGH phase pattern is determined so that an energy distribution in the multiple optical beams is adjusted to equalize a strength of returning signals assuming that a ratio of an apparent extent of the objects in the plurality of objects depends on distance to the objects.

In another embodiment, the camera arrangement is further configured to scan the optical beam over the ROI.

In another embodiment, the GPU is configured to determine the CGH phase pattern and cause the CGH phase pattern to be displayed using an interoperable compute unified device architecture (CUDA) and openGL platform.

In another embodiment, the phase-SLM is a phase light modulator (PLM).

In another embodiment, the phase-SLM is a Micro Electro-Mechanical System (MEMS)-PLM.

In another embodiment, the phase-SLM is a Liquid Crystal on Silicon (LCoS) SLM.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1a shows the Texas Instruments Phase Light Modulator (TI-PLM) (top) and an image of the pixels therein (bottom); and FIG. 1b is a schematic diagram of the computer-generated holograms (CGH) plane (xₕ, yₕ) and the image plane (Δxₖ, Δyₖ).

FIG. 2 is a schematic diagram illustrating the use of compute unified device architecture (CUDA) for the CGH calculation.

FIG. 3 shows an operational flow diagram of the CUDA-OpenGL interoperability process.

FIG. 4 shows a schematic diagram of the workflow for CUDA-OpenGL interoperability.

FIG. 5a shows a simplified example of an adaptive beam steering system that may be employed to implement the methods described herein; and FIG. 5b is a flowchart showing the operation of the adaptive beam steering system.

FIG. 6 shows three images of a scene to be scanned, where the scene includes three objects of interest each surrounded by a region of interest (ROI).

FIG. 7 schematically shows a phase-SLM and the CGH plane for purposes of calculating the CGH.

FIG. 8 schematically shows a phase-SLM and the CGH plane for purposes of calculating a CGH that simultaneously steers beams into two points, Q1 and Q2 while also varying the intensity of those beams.

### DETAILED DESCRIPTION

### Introduction

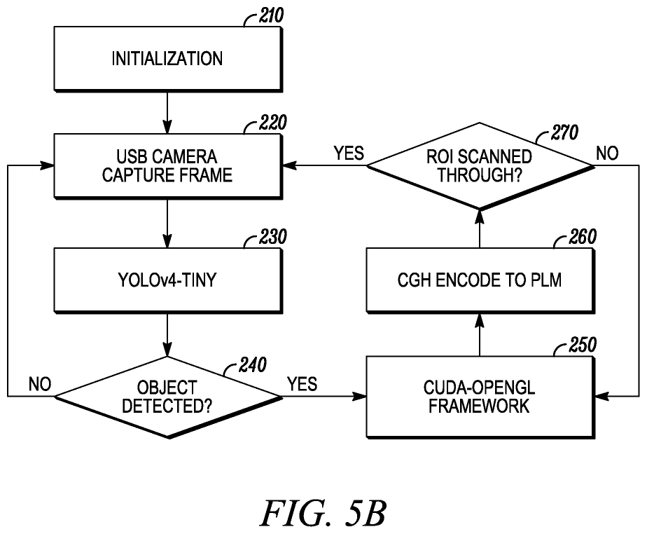

FIG. 5a shows a simplified example of an adaptive beam steering system 100 that may be employed to implement the methods described herein. The system 100 includes an optical beam source 110 such as a laser that directs an optical beam (e.g., a laser beam) onto a phase-SLM 120 (e.g., a PLM) via an optical system that may include, for example, a beam expander 130. The phase-SLM 120 steers the laser beam to a region of interest (ROI) in an image captured by a camera 140. A graphics processing unit (GPU) (illustrated in FIG. 5A as being embodied in computer 150) performs the calculations that are described herein for determining the phase pattern that is to be applied by the phase-SLM 120 to the optical beam. The GPU also communicates with the driver in phase-SLM 120 over a suitable interface to send the phase profile that is to be displayed.

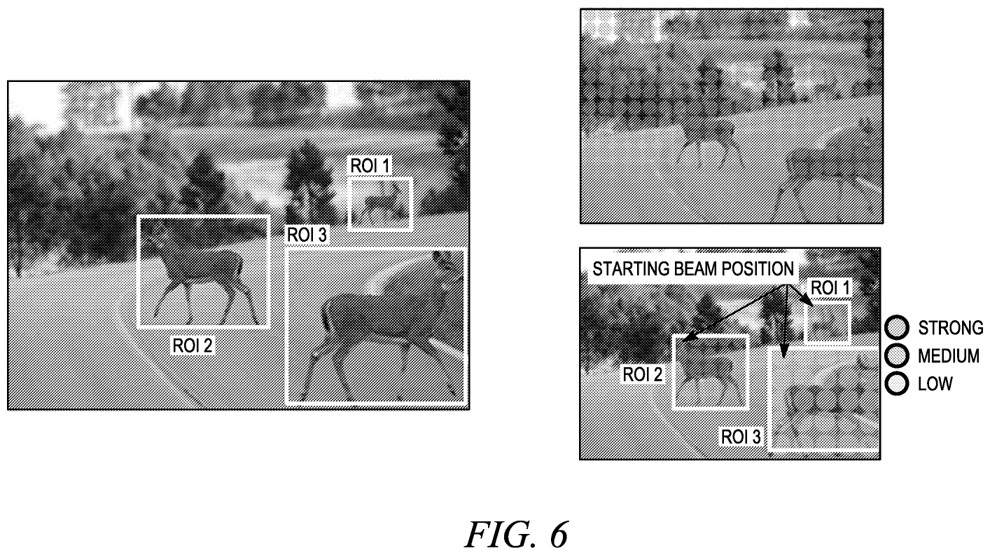

One example of an application to which the adaptive beam steering systems and methods described herein may employed is lidar (light detection and ranging). Recently developed lidar systems often require a more intelligent way to detect an objects' position and distance. In particular, scanning the laser beams only into the region of interest (ROI) can dramatically increase the frame rate while not sacrificing the resolution of the lidar image. FIG. 6 illustrates the overall concept with three objects of interest. Suppose we measure distance of three objects, say a deer. Conventionally, lidar detection employs raster scanning so that the entire field of view is uniformly sampled. In this raster scanning, the number of samples for the deer that appears smallest, due to the longer distance from the lidar system, is small compared to the deer which appears to be largest, due to its proximity to the lidar system. Moreover, while raster scanning, the intensity of the laser is uniform. Therefore, the returning signal from the more distant deer is substantially weaker compared to the signal from the deer that is closer to the lidar system. The large variation in the intensity of the returning signal requires high dynamic range detector.

These problems, a lower resolution for the more distant object and a variation in intensity of the returning signal, can be solved by simultaneously steering the laser to each of region of interest (ROI) encompassing the respective object (e.g., deer) while varying the intensity of the laser beam based on the camera input. First, the camera classifies the objects and defines region of interests (ROIs) that respectively encompass them. In the example of FIG. 6, the ROI1 has the ROI with the smallest extent. Once the ROIs are identified, then the optical beam is raster scanned within each of the ROIs simultaneously (ROI1, ROI2 and ROI3 in FIG. 6). For example, three beams are simultaneously steered into top-left corner of the ROIs. The intensity of laser beam is adjusted based on the extent of the ROIs. In this example, the beam intensity directed to ROI1 is the highest one while the beam intensity directed to ROI3 is the lowest. In this manner, the returning signal strength from each of the ROIs is equalized. Moreover, the number of scanning points within the ROIs are the same so that all the three objects are detected with the same resolution, and are scanned within the same duration of time.

The beam scanning with a phase-SLM requires the calculation of a computer generated hologram (CGH) so that multiple beams are steered into multiple ROIs while adaptively varying the beam intensity based on the camera input, such as apparent extent of object. Moreover, the calculation should be performed within the time duration of one frame of lidar live images operating at, e.g., 50-100 frames per second.

Conventionally, the CGH is calculated using an iterative algorithm such as the Gerchburg Saxton algorithm, which is prohibitive for applications such as those described herein due to the iterative and thus time-consuming nature of the calculation. Instead, the deterministic CGH calculation described herein enables a fast CGH calculation to be performed using a phase addition method.

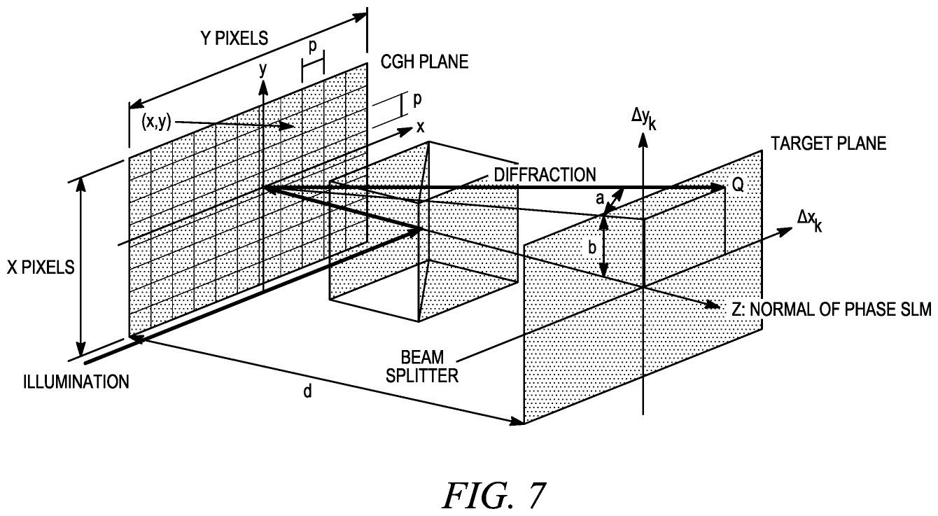

FIG. 7 schematically shows the phase-SLM and the CGH plane. The phase-SLM has X by Y pixels with a pixel period of p. A single illumination beam from an optical source typically illuminates the Phase-SLM with a plane wave, represented in the figure by an arrow. The illumination beam is diffracted by the Phase-SLM towards point Q1 (Δx, Δy) on a target plane placed at a distance of d from the CGH plane. The diffraction angles (a, b) represent angular coordinate of the target point Q and IS given by [a,b]=arctan (Δx/d, Δy/d). For the case of multiple and simultaneous beam steering towards additional points Q1, Q2, . . . diffraction angles [a1, b1], [a2, b2] are defined accordingly.

First we determine the phase ϕ to diffract the beam to a single point Q at each pixel of the Phase SLM. The phase value of the pixel located at (x, y)=(i×p, j×p), where p is the pixel period and i, j are integers, is determined by

$$ϕ ( x , y , a , b ) = mod \{ [ 2 π ( x \times a + y \times b ) ] , 2 π \} \qquad ( 1 )$$

where (x,y) and (a, b) represent the position of the pixel of the phase-SLM, and diffraction angle, respectively. The operation mod (2π(x×a+y×b), 2π) represents modulo 2π operation on the value 2π(x×a+y×b).

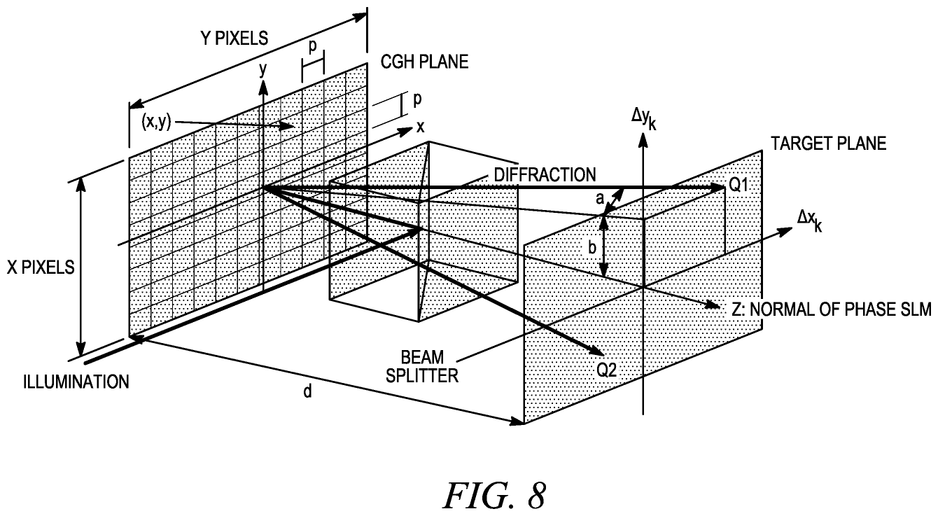

Next, we consider simultaneously steering beams into two points, Q1 and Q2 while varying the intensity of those beams as depicted in FIG. 8. The elemental phase profile of the 1^{st} CGH ϕ1 that diffracts the beam into point Q1, and the phase profile of the 2^{nd} CGH ϕ₂ that diffracts beam into point Q2 are added in electric fields, while multiplying the amplitude of each of the CGHs represented as A₁ and A₂ such as A₁e^{jϕ}^{₁}+A₂e^{jϕ}^{₂}. More generally, the phase to simultaneously steer a beam into multiple n points while varying the intensity to each of the points, is determined by:

$$θ ( x , y , {a}_{1} , {b}_{1} , ... , {a}_{n} , {b}_{n} ) = arg [ {\sum }_{k = 1}^{n} {A}_{k} {e}^{j {ϕ}_{k}} ] . \qquad ( 2 )$$

This calculation process is equivalently modified as follows:

$$θ ( x , y , {a}_{1} , {b}_{1} , ... , {a}_{n} , {b}_{n} ) = {tan}^{- 1} ( \frac{{\sum }_{k = 1}^{n} {A}_{k} sin ( {ϕ}_{k} )}{{\sum }_{k = 1}^{n} {A}_{k} cos ( {ϕ}_{k} )} ) \qquad ( 3 )$$

The modified phase profile is simply a sum of sine and cosine and one division operation at the location of pixel (x,y) for given diffraction angles (aₖ, bₖ), and the requirement on beam amplitude of beam from k-th CGH pattern. The parameters (aₖ, bₖ) and Aₖ are determined based on an external input such as location and apparent extent of the region of interest. For example, the apparent extent of the k-th ROI with angular an extent of Hₖ×Wₖ represents the distance to the object, provided that the actual extent of the objects are about the same for the same kind of object, i.e., a car. Based on this assumption, the Aₖ is calculated to be for example,

$${A}_{k} = \frac{1}{\sqrt{{H}_{k} \times {W}_{k}}} \qquad ( 4 )$$

For a larger extent, the target object is expected to be closer. Therefore, the amplitude of the laser beam is decreased. For objects with a smaller apparent extent, the amplitude of the laser beam is increased. In this way, the signal strength of the retuning signals from the object are equalized, since the returning signal decreases as (distance)⁻².

In some embodiments, the phase addition method effectively takes advantage of parallel processing by using a GPU (Graphical Processing Unit) that enables the calculation of the phase values of individual pixels in the PLM independently of the other pixels. In this manner, a fast calculation of the CGH phase profile is feasible within the time duration of single frame of a lidar image. Moreover, the phase profile calculated by the GPU can be directly streamed to the PLM driver by coordinating the streaming phase data pattern calculated by the GPU via a shared graphic memory with a display API such as OpenGL. In this manner, the CGH can be displayed on the PLM without transferring data from the GPU to a CPU. In this way the systems and methods described herein enable adaptive beam steering that is capable of i) on-the-fly beam steering to multiple ROIs while ii) varying the beam intensity ratio among multiple ROIs so that the retuning signal level is equalized. This method can consequently increase i) the frame rate of lidar scanning and ii) mitigate requirements on the dynamic range of the lidar detector.

For purposes of illustration and not as limitation on the systems and methods described herein, the phase-SLM in the following will be described in terms of a recently developed high-speed phase MEMS-PLM, the Texas Instruments Phase Light Modulator (TI-PLM). More generally, however, any suitable reflective or transmissive phase SLM may be employed.

In some embodiments described below, adaptive and foveated beam tracking with the TI-PLM involves three primary building blocks: (1) a GPU-based calculation of a CGH for multi-point beam steering, (2) CUDA-OpenGL interoperability to display a CGH on the TI-PLM, and (3) AI-based and real-time multiple object recognition by camera. Each of these building blocks will be discussed below.

### A CGH for Multi-Point and Variable Beam Ratio Steering

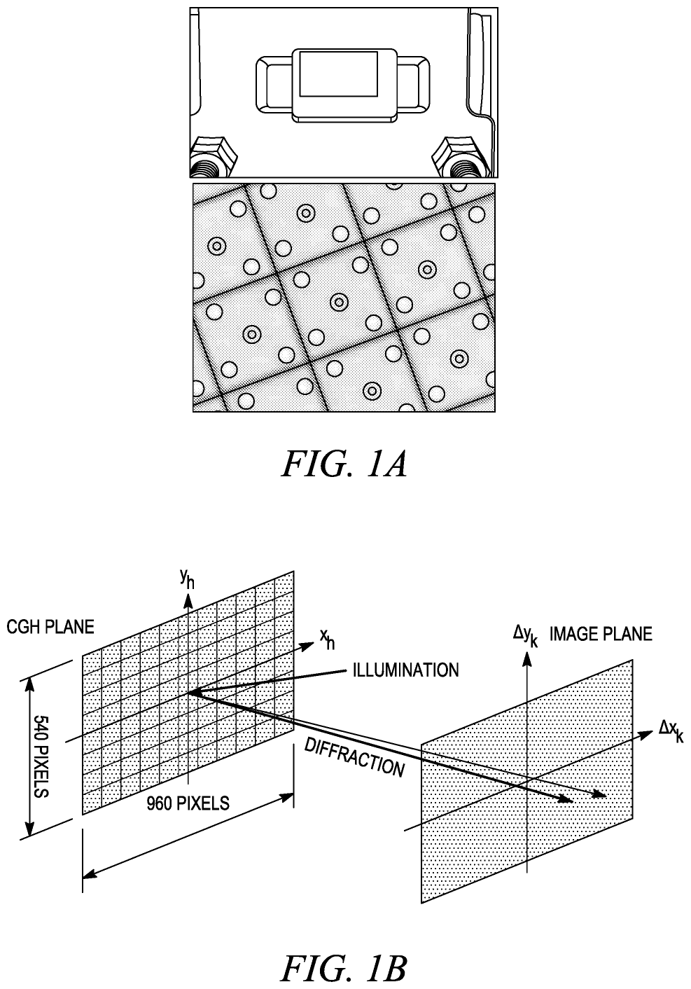

The TI-PLM is a MEMS-based reflective phase light modulator. The phase is modulated by a 960×540 pixel array of micromirrors with a pixel period d=10.8 um with piston motion. The maximum phase modulation depth of the current generation of the PLM is 2π at 633 nm. FIG. 1a shows the TI-PLM (top) and an image of the pixels therein (bottom). FIG. 1b is a schematic diagram of the CGH plane (xₕ, yₕ) and the image plane (Δxₖ, Δyₖ). For a given beam-steering angle (Δxₖ/f, Δyₖ/f), the phase of the pixel located at (xₕ, yₕ) is calculated by Equation 1 below.

The incident plane wave to the PLM is diffracted by the phase modulation in tilt across the PLM plane. Equivalently, a lateral shift of the focused spot is observed at the back focal plane of the lens placed between the PLM and the image plane. The lateral shift of the beam (Δxₖ, Δyₖ) is related to the phase of the SLM Øₖ(xₕ, yₕ) by,

$${ϕ}_{k} ( {x}_{h} , {y}_{h} , Δ {x}_{k} , Δ {y}_{k} ) = ( \frac{2 π}{λ f} ( Δ {x}_{k} {x}_{h} + Δ {y}_{k} {y}_{h} ) ) mod 2 π \qquad ( 1 )$$

where (xₕ, yₕ) is the pixel coordinate of the SLM and (Δxₖ, Δyₖ) is a lateral shift of the beam with respect to the 0^{th}-order beam indexed by k at the image plane of a focusing lens. f is the focal length of the lens. The maximum displacement \sqrt{Δxₖ²+Δyₖ²} is limited by the wavelength λ and the pixel pitch d and is given by Δf/2d.

We consider steering the beam into multiple points on the image plane while varying the power of each of the diffracted beams. Assuming a plane wave with unit amplitude illuminates the TI-PLM, the modulated field is given by,

$$ψ ( {x}_{h} , {y}_{h} , Δ {x}_{k} , Δ {y}_{k} ) = {\sum }_{k = 1}^{n} {A}_{k} {e}^{j {ϕ}_{k}} \qquad ( 2 )$$

For a phase-only MEMS-SLM, the phase θ of the hologram is given by,

$$θ ( {x}_{h} , {y}_{h} , Δ {x}_{k} , Δ {y}_{k} ) = arg ( {\sum }_{k = 1}^{n} {A}_{k} {e}^{j {ϕ}_{k}} ) \qquad ( 3 )$$

So far, we know the phase on the hologram plane to generate multiple points on the image plane. To decrease the computational time, Equation (3) can be re-written as,

$$θ ( {x}_{h} , {y}_{h} , Δ {x}_{k} , Δ {y}_{k} ) = {tan}^{- 1} ( \frac{{\sum }_{k = 1}^{n} {A}_{k} sin ( {ϕ}_{k} )}{{\sum }_{k = 1}^{n} {A}_{k} cos ( {ϕ}_{k} )} ) \qquad ( 4 )$$

Equations (3) and (4) generate identical phase holograms. However, with Equation (4), the computational time is substantially decreased. Equation (4) indicates that phase at each pixel coordinate (xₕ, yₕ) is independently calculated by summation operation. Due to the large amount of independency and low complexity in the computation of phase θ, the phase of each pixel can be processed in parallel by using CUDA (Compute Unified Device Architecture) with a GPU (Graphic Processing Unit). Further, a substantial part of rendering of a CGH and streaming them to the TI-PLM is also handled by the GPU by CUDA-OpenGL interoperability while applying a CGH rendering scheme specific to the TI-PLM. In this manner, data transfer required between the CPU and the GPU is minimized; consequently, the CGH computational time and display time are drastically decreased.

### Parallel Processing of CGH Calculation

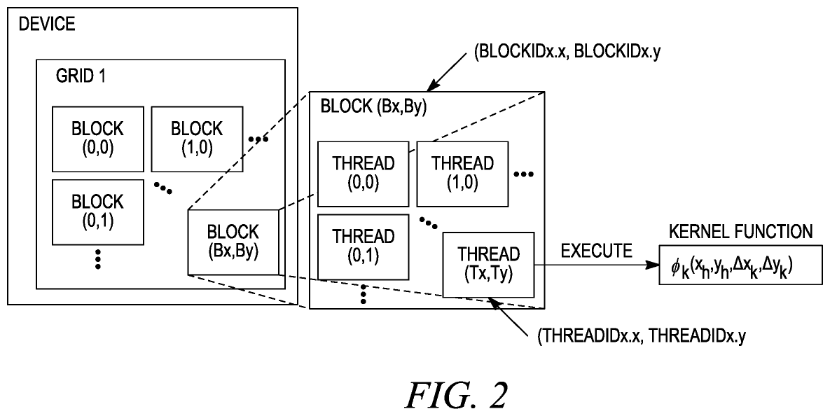

CUDA is a parallel programming platform introduced by NVIDIA to access GPU resources by organizing threads, blocks, and grids for CUDA kernel functions. In CUDA, a grid is composed of a set of blocks, and a block is composed of a set of threads. One thread is a unit of parallel processing in the GPU that handles calculation of the phase of a single pixel (FIG. 2). FIG. 2 is a schematic diagram illustrating the use of CUDA for the CGH calculation. Each thread handles a pixel of a CGH, calculating the phase value using Equation (1) for single-beam steering, or Equation (4) for multi-beam steering. Δxₖ and Δyₖ are the lateral shift in the x and y direction (see FIG. 1b), respectively.

Since the TI-PLM has 960×540 physical pixels, we allocate (32, 30) threads in a single block, and (30, 18) blocks in a grid, which results in (960, 540) threads, and the CGH of (960, 540) pixel area is generated.

The pixel position (xₕ, yₕ) and the index of the blocks and threads in a block are related by the parameter set of (threadIdx.x, threadIdx.y) as the thread index, (blockDim.x, blockDim.y) as the number of threads in a block, i.e., (32, 30) in our case, and (blockIdx.x, blockIdx.y) as the indices of the blocks. Phase values ϕₖ(xₕ, yₕ, Δxₖ, Δyₖ) for a given (Δxₖ, Δyₖ) is computed in a distributed manner. Computational results at each of the pixel positions (xₕ, yₕ) are compiled by using indices and are given by,

$${x}_{h} = blockIdx . x \times blockDim . x + threadIdx . x \qquad ( 5 )$$

$${y}_{h} = blockIdx . y \times blockDim . y + threadIdx . y \qquad ( 6 )$$

For example, the phase at a pixel position of (102, 334) for single-beam steering is represented by

$${ϕ}_{k} ( 102 , 334 , Δ {x}_{k} , Δ {y}_{k} ) = ( \frac{2 π}{λ f} ( 102 Δ {x}_{k} + 334 Δ {y}_{k} ) ) mod 2 π .$$

### CUDA-OpenGL Interoperability for CGH Calculation, Rendering and Display

CUDA-OpenGL interoperability combines the advantages of GPU-based calculation and GPU-accelerated display via sharing OpenGL resources with CUDA, and mapping a buffer object from OpenGL to CUDA memory.

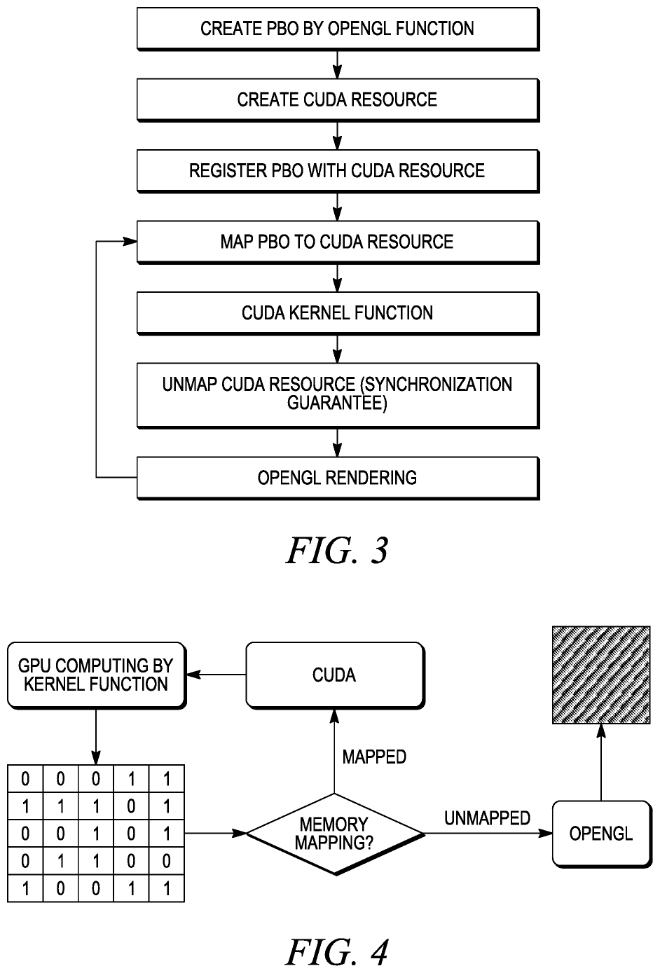

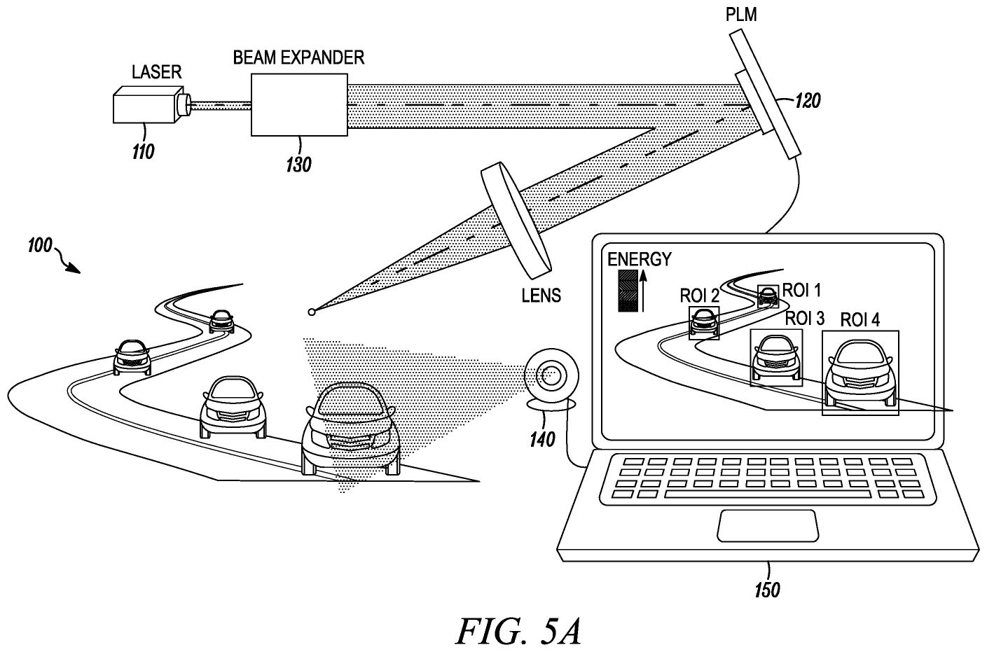

To implement CUDA-OpenGL interoperability, the CUDA resource should share the memory with a pixel buffer object created by OpenGL. FIG. 3 shows an operational flow diagram of the CUDA-OpenGL interoperability process. First, we declare global variables that will be used to store handles to the data we intend to share between OpenGL and CUDA, and then initialize the OpenGL library (GLUT) and create a graphics window. The pixel buffer object (PBO) stores the pixel data and asynchronously transfers the pixel data to the graphic card without wasting CPU cycles. Next, we register the PBO with the CUDA resource to share the buffer with both OpenGL and CUDA drivers. Then, we map the buffer to CUDA memory, meaning pointing the pointer of CUDA memory to the OpenGL buffer. Next, we use CUDA to calculate the pixel data through the kernel function and store the mapped memory so that OpenGL can render the results directly once the mapping between CUDA and the buffer is cancelled as well as mapping the buffer to CUDA to keep processing until the next frame is initiated. FIG. 4 shows a schematic diagram of the workflow for CUDA-OpenGL interoperability. CUDA and OpenGL share the same memory by mapping the buffer with CUDA. Once it has unmapped the buffer, OpenGL can directly render the calculated CGH. The workflow minimizes data transfer between the CPU and the GPU and maximizes the throughput of CGH calculation.

Multi-Point and Real-Time Beam Tracking System with Camera-Based Adaptive Beam Steering and Pre-Estimation of the Position and Size of the Target

As previously mentioned, CUDA-OpenGL interoperability enables the fast calculation of a CGH based on real-time input, e.g., camera-based object detection. An example of a simplified adaptive beam steering system was discussed above in connection with FIG. 5a. FIG. 5b is a flowchart showing the operation of the adaptive beam steering process. First, after an initialization step 210, in step 220 the camera captures a frame of an image of multiple objects within a scene. Next, object recognition is performed in step 230 to identify the objects and their position and within a FOV. The object recognition may be performed, for example, by a YOLOv4-tiny pretrained model. When the object of interest is detected at decision step 240, the coordinates and the extent of ROIs will be assigned to the GPU-based CGH processing framework in step 250. The calculated CGH is displayed on the PLM 120 by communicating it from the computer 150 to the PLM 120 over a suitable interface (e.g., HDMI) in step 260. The camera will capture the next frame once the objects of interest in the previous scene are scanned through at decision step 270. In this manner, a CGH simultaneously steers beams into multiple ROIs that are calculated and displayed on the PLM. Furthermore, with Equation 4, the CGH is capable of controlling the beam energy distribution to equalize the returning signal strength by assuming that the ratio of the apparent extent of objects depends on distance. For example, as shown in FIG. 5a, the relative appearance of multiple cars indicates the relative distance of multiple ROIs. Within the ROIs, objects are sequentially scanned while allocating appropriate beam power to each of the ROIs.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

1. A method for performing adaptive beam steering to one or more objects of interest, comprising
(i) detecting an object of interest in an image of a scene;
(ii) defining a region of interest (ROI) in the image to be scanned by an optical beam, wherein the ROI includes the object of interest;
(iii) determining a computer generated hologram (CGH) phase pattern to be applied to an optical beam by a phase Spatial Light Modulator (phase-SLM) to scan the optical beam over the ROI by diffractive beam steering, wherein the determining is performed by a CGH calculation algorithm that is executed in parallel for each of the pixels, wherein the determining includes determining the CGH phase pattern on a pixel-by-pixel-basis by assigning a phase value to each pixel in the phase-SLM based on the equation: ϕ(x, y, a, b)=mod {[2π(xa+yb)], 2π}, where ϕ is the phase value, (x,y) represents a position of the pixel, and (a, b) represents a diffraction angle measured from a 0^{th} order diffraction from the phase-SLM and mod (2π(xa+yb), 2π) represents a modulo 2π operation on a value 2π(xa+yb);
(iv) displaying the CGH phase pattern on the phase-SLM using a graphic memory that is also used to determine the CGH phase pattern; and
(v) directing the optical beam onto the phase-SLM while the CGH phase pattern is being displayed to thereby steer the optical beam to the ROI.

2. The method of claim 1 further comprising simultaneously performing (i)-(v) for a plurality of objects defined in a plurality of ROIs in the image by simultaneously steering a plurality of optical beams, wherein the determining includes determining the CGH phase pattern so that the CGH pattern diffracts a single incoming illumination beam into multiple optical beams in such a way that each of the optical beams are directed towards different ROIs based on summing multiple diffracted electric fields, each of the diffracted electric fields diffracting light toward one of the ROIs followed by determining the CGH phase pattern as being represented as argument values of the summed multiple diffracted electric fields.

3. The method of claim 1 wherein determining the CGH phase pattern determines the CGH so that an energy distribution in the multiple optical beams is adjusted to equalize a strength of returning signals assuming that a ratio of an apparent extent of the objects in the plurality of objects depends on distance to the objects.

4. The method of claim 1 further comprising scanning the optical beam over the ROI.

5. The method of claim 1 further comprising performing foveated lidar using the scanned optical beam.

6. The method of claim 1 wherein determining the CGH phase pattern is performed using a graphical processing unit (GPU).

7. The method of claim 6 wherein the determining and displaying are performed using an interoperable compute unified device architecture (CUDA) and OpenGL platform.

8. The method of claim 1 wherein the phase-SLM is a phase light modulator (PLM).

9. The method of claim 1 wherein the phase-SLM is a Micro Electro-Mechanical System (MEMS)-PLM.

10. The method of claim 1 wherein the phase-SLM is a Liquid Crystal on Silicon (LCoS) SLM.

11. An adaptive beam steering system, comprising:
a camera arrangement configured to detect at least one object of interest in a region of interest (ROI) located in an image of a scene;
an optical source for generating an optical beam;
a phase spatial light modulator (phase-SLM) being arranged to receive the optical beam; and
a graphical processing unit (GPU) being configured to determine a computer generated hologram (CGH) phase pattern to be applied to an optical beam by the phase-SLM to scan the optical beam over the ROI by diffractive beam steering, wherein the GPU is further configured to determine the CGH phase pattern using a CGH calculation algorithm that is executed in parallel for each of the pixels, wherein the determining includes determining the CGH phase pattern on a pixel-by-pixel-basis by assigning a phase value to each pixel in the phase-SLM based on the equation: ϕ(x, y, a, b)=mod {[2π(xa+yb)], 2π}, where ϕ is the phase value, (x,y) represents a position of the pixel, and (a, b) represents a diffraction angle measured from a 0^{th} order diffraction from the phase-SLM and mod (2π(xa+yb), 2π) represents a modulo 2π operation on a value 2π(xa+yb), the GPU being further configured to cause the CGH phase pattern to be displayed on the phase-SLM while the optical beam is being directed on the phase-SLM to thereby steer the optical beam to the ROI.

12. The adaptive beam steering system of claim 11 wherein the camera arrangement is configured to detect a plurality of objects defined in a plurality of ROIs in the image, the GPU being further configured to cause simultaneous steering of a plurality of optical beams, wherein the GPU is further configured to determine the CGH phase pattern so that the CGH pattern diffracts the optical beam into multiple optical beams in such a way that each of the multiple optical beams are directed towards different ROIs based on summing multiple diffracted electric fields, each of the diffracted electric fields diffracting light toward one of the ROIs followed by determining the CGH phase pattern as being represented as argument values of the summed multiple diffracted electric fields.

13. The adaptive beam steering system of claim 12 wherein determining the CGH phase pattern determines the CGH so that an energy distribution in the multiple optical beams is adjusted to equalize a strength of returning signals assuming that a ratio of an apparent extent of the objects in the plurality of objects depends on distance to the objects.

14. The adaptive beam steering system of claim 11 wherein the camera arrangement is further configured to scan the optical beam over the ROI.

15. The adaptive beam steering system of claim 11 wherein the GPU is configured to determine the CGH phase pattern and cause the CGH phase pattern to be displayed using an interoperable compute unified device architecture (CUDA) and openGL platform.

16. The adaptive beam steering system of claim 11 wherein the phase-SLM is a phase light modulator (PLM).

17. The adaptive beam steering system of claim 11 wherein the phase-SLM is a Micro Electro-Mechanical System (MEMS)-PLM.

18. The adaptive beam steering system of claim 11 wherein the phase-SLM is a Liquid Crystal on Silicon (LCOS) SLM.
